(19) United States
(12) Patent Application Publication
(10) Pub. No.: US 2024/0382836 A1
(43) Pub. Date: Nov. 21, 2024

(54) INFORMATION PROCESSING APPARATUS, PROGRAM, AND OBJECT CREATION METHOD

(71) Applicant: KOEI TECMO GAMES CO., LTD., Yokohama-shi, Kanagawa (JP)

(72) Inventor: Kazumi FUJITA, Kanagawa (JP)

(21) Appl. No.: 18/693,138

(22) PCT Filed: Oct. 26, 2022
(86) PCT No.: PCT/JP2022/040032

§ 371 Date: Mar. 18, 2024

(30) Foreign Application Priority Data
Oct. 26, 2021 (JP) 2021-174957
May 30, 2022 (JP) 2022-087959

(51) Int. Cl. A63F 13/235; A63F 13/60

(52) U.S. Cl. CPC A63F 13/235; A63F 13/60

(57) ABSTRACT

Provided is an information processing apparatus including designated object creation means for creating a designated object in a case where record data of an IC card, which is read from an IC tag or an IC chip in which information of the IC card is registered satisfies a condition, and related object creation means for creating, in a case where the record data does not satisfy the condition, a related object according to an elapsed time from reading of the record data to reading of next record data and presence or absence of a change in the next record data read.

### TECHNICAL FIELD

The present disclosure relates to an information processing apparatus, a program, and an object creation method.

### BACKGROUND ART

For example, it has been previously considered to perform certain entertainment using a use history recorded in a transportation IC card. Conventionally, for example, a game using a use history of a transportation IC card is known (see, for example, Patent Document 1).

### CITATION LIST

### Patent Document

Patent Document 1: Japanese Patent Application Laid-Open (JP-A) No. 2017-131673

### SUMMARY OF INVENTION

### Technical Problem

For example, in a case where information is read from an IC card such as a transportation IC card and an object is created based on the read information, it is desirable to impart game properties to object creation in order to improve curiousness and play motivation of a user.

An object of the disclosure is to impart game properties to object creation performed by reading information of an IC card.

### Solution to Problem

According to the disclosure, there is provided an information processing apparatus including designated object creation means for creating a designated object in a case where record data of an IC card, which is read from an IC tag or an IC chip in which information of the IC card is registered satisfies a condition, and related object creation means for creating, in a case where the record data does not satisfy the condition, a related object according to an elapsed time from reading of the record data to reading of next record data and presence or absence of a change in the next record data read.

### Advantageous Effects of Invention

According to the disclosure, it is possible to impart game properties to object creation performed by reading information of an IC card.

### BRIEF DESCRIPTION OF DRAWINGS

FIG. 1A is a diagram illustrating an example of a relationship between an IC card and an information processing apparatus.

FIG. 1B is a diagram illustrating another example of the relationship between the IC card and the information processing apparatus.

FIG. 2 is a configuration diagram of an example of an information processing system according to the present embodiment.

FIG. 3 is a diagram illustrating an example of a hardware configuration of the information processing apparatus according to the present embodiment.

FIG. 4 is a diagram illustrating an example of a functional configuration of the information processing apparatus according to the present embodiment.

FIG. 5 is a flowchart of an example of object creation processing according to the present embodiment.

FIG. 6 is a flowchart of an example of a designated object creation process according to the present embodiment.

FIG. 7 is an example of a table in which designated object information is associated with a numerical progression for generating a designated object.

FIG. 8 is an image diagram of an example of an announcement production screen.

FIG. 9 is a flowchart of an example of a re-reading process according to the present embodiment.

FIG. 10 is a flowchart of an example of a designated object creation process in the case of NFC with record data of a balance.

FIG. 11 is a flowchart of another example of the designated object creation process in the case of NFC with record data of the balance.

FIG. 12A is an example of a table in which designated object information is associated with a numerical progression for generating a designated object.

FIG. 12B is another example of a table in which the designated object information is associated with the numerical progression for generating the designated object.

FIG. 13 is a flowchart of an example of a designated object creation process in the case of NFC having a UID without record data of a balance.

FIG. 14 is a flowchart of another example of the designated object creation process in the case of NFC having the UID without the record data of the balance.

FIG. 15 is a flowchart of an example of a designated object creation process in the case of NFC having a random UID without record data of a balance.

FIG. 16 is a flowchart of another example of the designated object creation process in the case of NFC having the random UID without the record data of the balance.

### DESCRIPTION OF EMBODIMENTS

Hereinafter, modes for carrying out the disclosure will be described with reference to the drawings.

### First Embodiment

[Relationship between IC Card and Information Processing Apparatus]

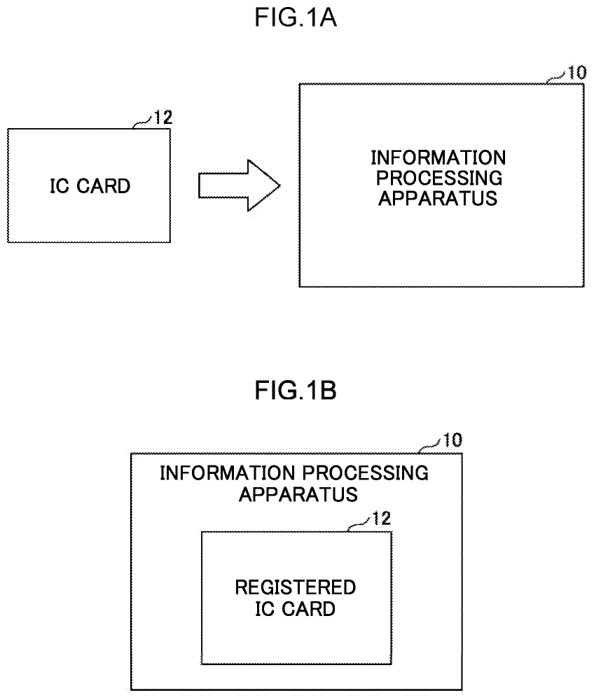

First, a relationship between an IC card and an information processing apparatus according to the present embodiment will be described with reference to FIGS. 1A and 1B. FIGS. 1A and 1B are diagrams illustrating examples of the relationship between the IC card and the information processing apparatus. As illustrated in FIG. 1A, an information processing apparatus 10 according to the present embodiment can read information of an IC card from an IC card 12, for example, by using near field communication (NFC). The IC card 12 is not limited to a non-contact type, and may be a contact type.

The IC card 12 incorporates an IC tag or an IC chip, and can read and write data. Here, an example in which record data that varies by use is registered as one piece of information of the IC card 12 will be described. Examples of the record data that varies by use include a balance of a charged amount of electronic money, a balance of points, a movement history, and a use history. The use of the IC card 12 includes payment with a charged amount, depositing money to the charged amount, usage of points, addition of points, and the like.

As illustrated in FIG. 1B, in a case where an IC tag or an IC chip is mounted in the information processing apparatus 10 according to the present embodiment, the information processing apparatus 10 registers information of one or more IC cards 12, and can read and write data from and in the registered IC card 12.

The information processing apparatus 10 in which the information of the IC card 12 illustrated in FIG. 1B is registered functions as the IC card 12 illustrated in FIG. 1A, and can cause another information processing apparatus 10 to read the information of the IC card 12.

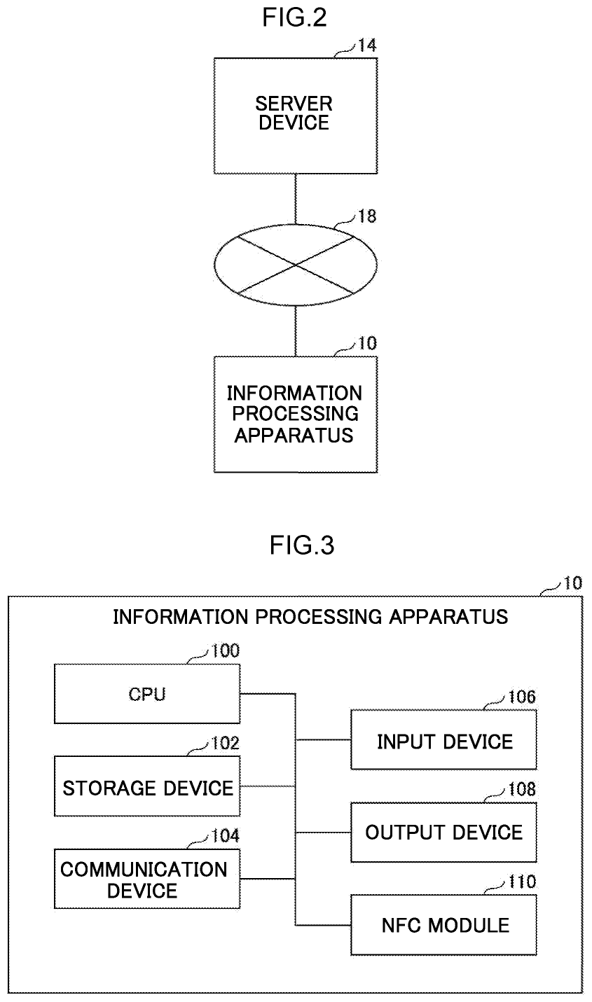

The information processing apparatus 10 according to the present embodiment creates an object to be used in a game, a social networking service (SNS), or the like by using record data read from the IC card 12 in FIG. 1A or 1B as described later. A character and an item used in a game, an SNS, or the like are examples of the object. The information processing apparatus 10 according to the present embodiment may use, for example, an information processing system illustrated in FIG. 2 to acquire information from a server device 14 and use the information to create an object.

FIG. 2 is a configuration diagram of an example of an information processing system according to the present embodiment. The information processing apparatus 10 is an information communication terminal such as a smartphone, a tablet terminal, a PC, or a game machine. The information processing apparatus 10 communicates with the server device 14 via a communication network 18 such as the Internet or a local area network (LAN).

For example, the information processing apparatus 10 may acquire, from the server device 14, a movement distance corresponding to a movement history which is an example of record data read from the IC card 12. The information processing apparatus 10 may acquire character data and item data used to create an object from the server device 14.

### [Hardware Configuration]

FIG. 3 is a diagram illustrating an example of a hardware configuration of the information processing apparatus according to the present embodiment.

The information processing apparatus 10 in FIG. 3 includes, for example, a central processing unit (CPU) 100, a storage device 102, a communication device 104, an input device 106, an output device 108, and an NFC module 110. The CPU 100 controls the information processing apparatus according to a program. The storage device 102 is, for example, a memory such as a read only memory (ROM) or a random access memory (RAM), or a storage such as a hard disk drive (HDD) or a solid state drive (SSD). The storage device 102 stores a program executed by the CPU 100 and data. The program may be recorded in a computer-readable recording medium such as a USB memory.

The communication device 104 is a communication device such as a network circuit that controls communication. The input device 106 is an input device such as a touch pad, a controller, a mouse, a keyboard, a camera, or a microphone. The output device 108 is an output device such as a display or a speaker. The touch panel is realized by combining a touch pad which is an example of the input device 106 and a display which is an example of the output device 108.

The NFC module 110 is a module with an antenna compatible with a near field communication technology. The NFC module 110 reads information of the IC card 12 from the IC tag or the IC chip built into the IC card 12 and writes information of the IC card 12 to the IC tag or the IC chip. By using the NFC module 110, the information processing apparatus 10 can acquire information of the IC card 12 in FIG. 1A, for example. By using the NFC module 110, the information processing apparatus 10 can also function as the registered IC card 12 as illustrated in FIG. 1B, for example.

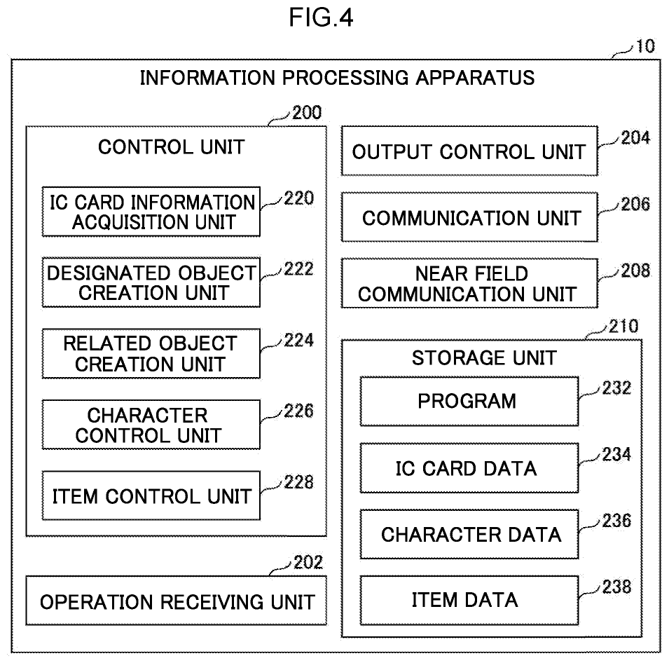

The system configuration in FIG. 2 and the hardware configuration in FIG. 3 are examples. The server device 14 may be realized by a cloud computer. The number of server devices 14 is not limited to one, and two or more server devices may perform distributed processing. The server device 14 may be used for download processing or the like for providing a program required by the information processing apparatus 10.

[Functional Blocks] FIG. 4 is a diagram illustrating an example of a functional configuration of the information processing apparatus according to the present embodiment. The information processing apparatus 10 in FIG. 4 includes a control unit 200, an operation receiving unit 202, an output control unit 204, a communication unit 206, a near field communication unit 208, and a storage unit 210.

The storage unit 210 stores a program 232, IC card data 234, character data 236, and item data 238. The storage unit 210 may be realized by the storage device 102 or may be realized by a storage device connected via the communication network 18 or the like.

The IC card data 234 is information of the IC card 12, and includes various types of data such as record data that varies by the use of the IC card 12. The IC card data 234 may include information of one or more IC cards 12. The character data 236 includes data necessary for creating a character by using the information of the IC card 12 and data of a character created by using the information of the IC card 12. The item data 238 includes data necessary for creating an item by using the information of the IC card 12 and data of an item created by using the information of the IC card 12.

The control unit 200 performs the overall control of the information processing apparatus 10. The overall control of the information processing apparatus 10 includes, for example, control of creating and displaying a character and an item as described later, based on the read information of the IC card 12.

The control unit 200 is realized by the CPU 100 performing processing described in the program 232. The control unit 200 includes an IC card information acquisition unit 220, a designated object creation unit 222, a related object creation unit 224, a character control unit 226, and an item control unit 228.

The IC card information acquisition unit 220 acquires information from the IC card 12, for example, by using a near field communication technology. The designated object creation unit 222 creates a designated object as described later, by using the information of the IC card 12. The related object creation unit 224 creates a related object as described later, by using the information of the IC card 12. The designated object created by the designated object creation unit 222 and the related object created by the related object creation unit 224 are characters, items, and the like used in a game, an SNS, or the like.

The character control unit 226 performs control related to a designated character, which is an example of a designated object created by the designated object creation unit 222, and a related character, which is an example of a related object created by the related object creation unit 224, in a game, an SNS, or the like. The item control unit 228 performs control related to a related item, which is an example of a related object created by the related object creation unit 224, in a game, an SNS, or the like.

The operation receiving unit 202 receives various operations of a user on the input device 106. The output control unit 204 displays various screens on the output device 108 under the control of the control unit 200. The operation receiving unit 202 is realized by the CPU 100 controlling the input device 106 according to the program 232. The output control unit 204 is realized by the CPU 100 controlling the output device 108 according to the program 232. The various operations of the user on the input device 106 refer to operations of the user operating the operation receiving unit 202 in order to cause the CPU 100 to perform processing. The output control unit 204 displays various screens and outputs sounds under the control of the control unit 200.

The communication unit 206 communicates via the communication network 18 or the like. The communication unit 206 is realized in a manner that the CPU 100 executes the program 232 and controls the communication device 104 according to the program 232. The near field communication unit 208 uses, for example, a near field communication technology to read various types of data such as information of the IC card 12 from the IC card 12. The near field communication unit 208 is realized in a manner that the CPU 100 executes the program 232 and controls the NFC module 110 according to the program 232.

### [Processing]

As illustrated in FIG. 1A, the information processing apparatus 10 can read the information of the IC card 12 from the IC card 12. The information processing apparatus 10 can also read information of the IC card 12 from the registered IC card 12 as illustrated in FIG. 1B. The information processing apparatus 10 can also read the information of the IC card 12 from the information processing apparatus 10 in FIG. 1B by using the information processing apparatus 10 illustrated in FIG. 1B as the IC card 12 in FIG. 1A.

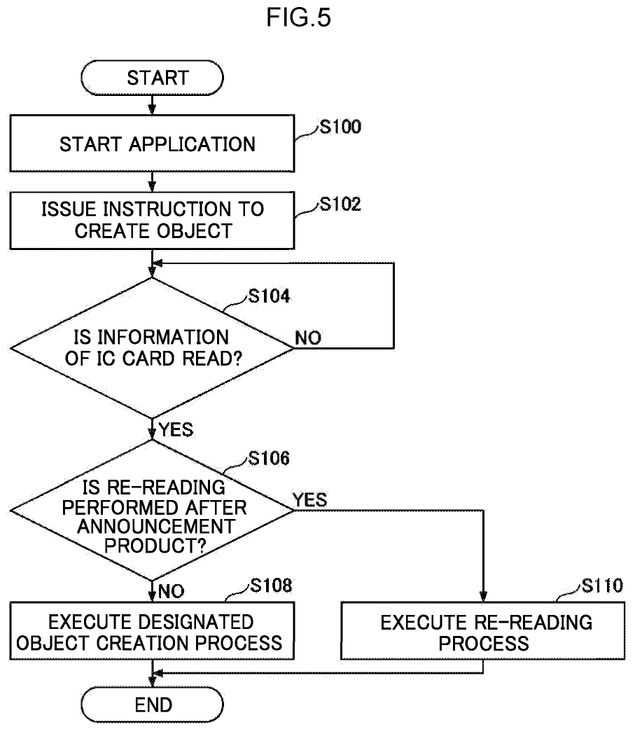

An example of reading the information of the IC card 12 from the IC card 12 as illustrated in FIG. 1B will be described below. FIG. 5 is a flowchart of an example of object creation processing according to the present embodiment. The record data that varies by the use of the IC card 12 varies, for example, by the user using the IC card 12 for payment.

In Step S100, the information processing apparatus 10 receives, from the user, a start operation of an application such as a game or an SNS in which a character and an item are created and used as an object. The information processing apparatus 10 starts the application of which the start operation is received. The application is an example of the program 232.

In Step S102, the information processing apparatus 10 receives an object creation instruction from the user who uses the started application, for example. The IC card information acquisition unit 220 in the information processing apparatus 10 repeats the process of Step S104 until the information of the IC card 12 is read from the IC card 12.

In a case where the information of the IC card 12 is read out from the IC card 12, the designated object creation unit 222 in the information processing apparatus 10 determines in Step S106 whether or not this reading is re-reading after an announcement production which will be described later. In a case where this reading is not re-reading after the announcement production which will be described later, the designated object creation unit 222 executes a designated object creation process of Step S108. In the case of the re-reading after the announcement production which will be described later, the related object creation unit 224 executes a re-reading process of Step S110.

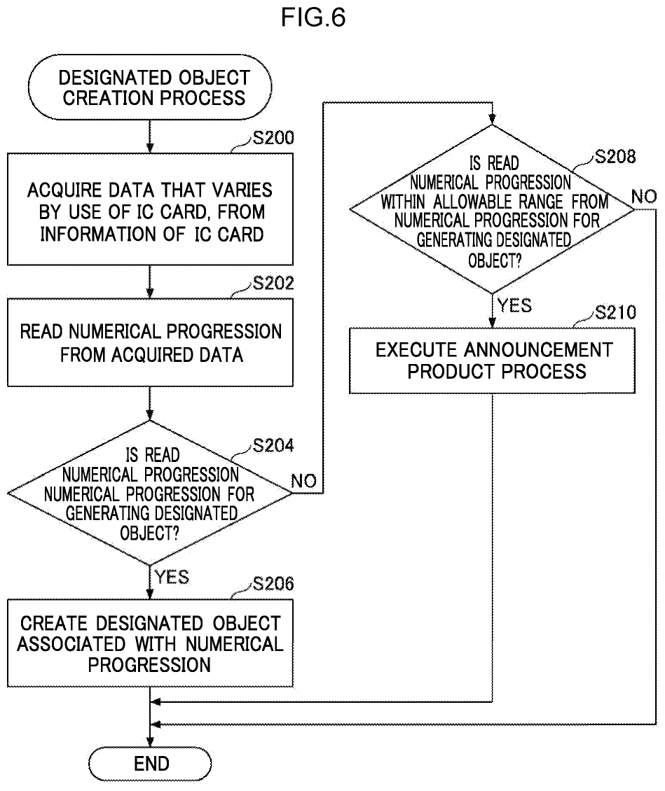

In Step S108, the designated object creation unit 222 creates a designated object by the procedure illustrated in FIG. 6, for example, using the information of the IC card 12 read from the IC card 12.

FIG. 6 is a flowchart of an example of the designated object creation process according to the present embodiment. In Step S200, the designated object creation unit 222 acquires record data that varies by the use of the IC card 12, from the information of the IC card 12.

The record data that varies by the use of the IC card 12, the record data being acquired in Step S200 may be a numerical progression from which any number of digits can be read. For example, the record data that varies by the use of the IC card 12 is the balance of the charged amount of electronic money, the balance of points, and the like. The record data that varies by the use of the IC card 12 may be data that can be converted into a numerical progression from which any number of digits can be read. Data that can be converted into a numerical sequence from which any number of digits can be read is, for example, a movement history from which a movement distance can be calculated.

Here, an example in which the record data that varies by the use of the IC card 12 is the balance of the charged amount of electronic money will be described. In Step S202, the designated object creation unit 222 reads a numerical progression of a predetermined number of digits (for example, the last three digits) from the numerical progression representing the balance of the charged amount of the IC card 12 acquired from the information of the IC card 12 in Step S200.

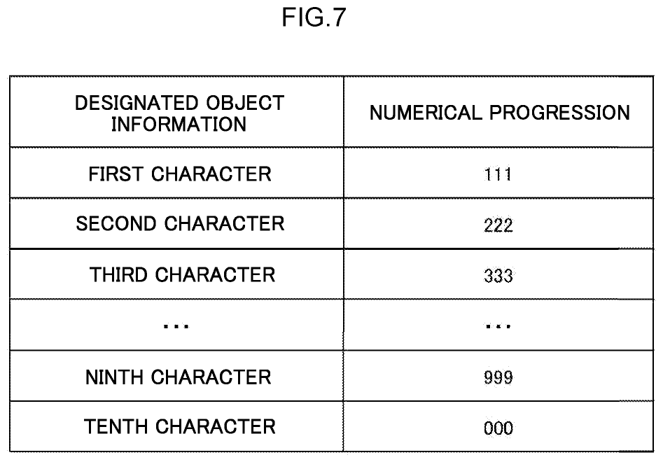

In Step S204, the designated object creation unit 222 determines whether or not the numerical progression of a predetermined number of digits read in Step S202 satisfies a condition for generating a designated object. Here, as an example of the condition for generating the designated object, an example of determining whether or not the numerical progression of a predetermined number of digits read in Step S202 is a numerical progression for generating the designated object will be described. The numerical progression for generating the designated object is managed, for example, by the table of FIG. 7, in association with designated object information. FIG. 7 is an example of the table in which the designated object information is associated with the numerical progression for generating designated objects. The designated object information is an example of identification information of the designated object. The numerical progression for generating the designated object is an example of a setting value associated with the designated object.

FIG. 7 illustrates an example in which the designated object is a character. FIG. 7 illustrates a table example in a case where the numerical progression of the predetermined number of digits has the same number (so-called repdigit), and the designated object is generated, but the numerical progression does not necessarily have repdigit. The table in FIG. 7 is included in, for example, the character data 236.

In a case where it is determined that the numerical progression of the predetermined number of digits read in Step S202 coincides with the numerical progression for generating the designated object, the designated object creation unit 222 executes the process of Step S206. In Step S206, the designated object creation unit 222 refers to the table in FIG. 7 and creates a designated object associated with the numerical progression of the predetermined number of digits read in Step S202. For example, in the example of the table in FIG. 7, in a case where the numerical progression of the predetermined number of digits read in Step S202 is “222”, “second character” is created as the designated object.

In a case where it is determined that the numerical progression of the predetermined number of digits read in Step S202 is not the numerical progression for generating the designated object, the designated object creation unit 222 proceeds to the process of Step S208. In Step S208, the related object creation unit 224 determines whether or not the numerical progression of the predetermined number of digits read in Step S202 is within an allowable range (for example, within ±5) from the numerical progression for generating the designated object.

In a case where the numerical progression of the predetermined number of digits read in Step S202 is within the allowable range from the numerical progression for generating the designated object, the related object creation unit 224 executes the process of Step S210. In Step S210, the related object creation unit 224 stores the numerical progression of the predetermined number of digits read in Step S202.

In Step S210, the related object creation unit 224 stores a predetermined time corresponding to a difference amount (difference) between the numerical progression of the predetermined number of digits read in Step S202 and the charged amount necessary for creating the designated object.

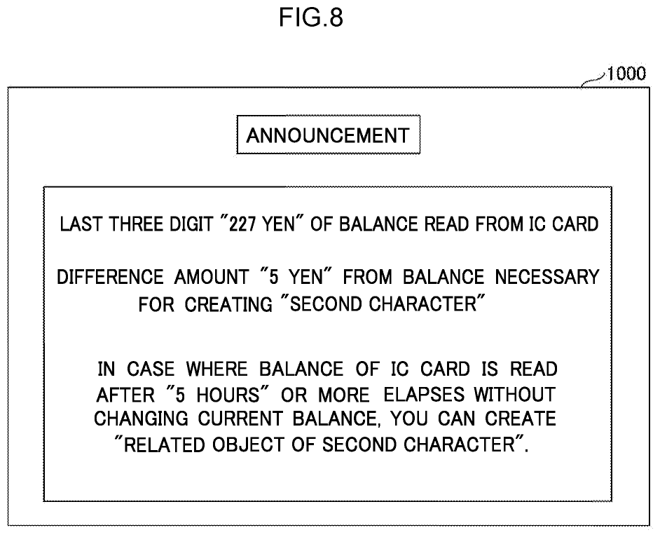

In Step S210, the related object creation unit 224 executes an announcement production process of displaying an announcement production screen 1000 as illustrated in FIG. 8, for example.

FIG. 8 is an image diagram of an example of the announcement production screen. The announcement production screen 1000 in FIG. 8 displays that the last three digits of the balance of the charged amount read from the IC card 12 are “227”, that the difference amount from the charged amount necessary for creating the second character is “5 yen”, and that the related object of the second character can be created by reading the balance of the charged amount of the IC card 12 after “5 hours” or more has elapsed without changing the current balance.

The announcement production screen 1000 in FIG. 8 determines “5 hours”, which is an example of the predetermined time, based on the difference amount between the last three digits “227” of the balance of the charged amount read from the IC card 12 and the charged amount “222” necessary for creating the second character. The predetermined time may be “5 minutes or 50 minutes”, for example. The announcement production screen 1000 in FIG. 8 is an example, and it is not necessarily necessary to display all types of the information illustrated in FIG. 8.

In a case where the numerical progression of the predetermined number of digits read in Step S202 is not within the allowable range from the numerical progression for generating the designated object, the related object creation unit 224 skips the announcement production process of Step S210. Thus, in a case where the numerical progression of the predetermined number of digits read in Step S202 is not within the allowable range from the numerical progression for generating the designated object, the related object creation unit 224 does not create the related object.

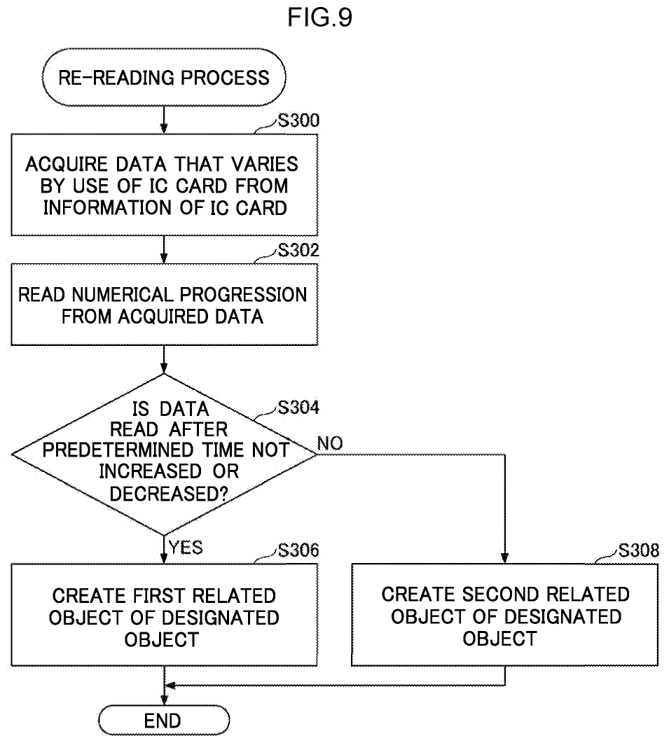

In Step S110 in FIG. 5, the related object creation unit 224 creates the related object by using the information of the IC card 12 read from the IC card 12. FIG. 9 is a flowchart of an example of the re-reading process according to the present embodiment.

In Step S300, the related object creation unit 224 acquires record data that varies by the use of the IC card 12, from the information of the IC card 12. The record data acquired in Step S300 may be referred to as next record data in the following description in order to be distinguished from the record data acquired in Step S200. The record data acquired in Step S200 may be referred to as previous record data.

In Step S302, the related object creation unit 224 reads a numerical progression of a predetermined number of digits (for example, the last three digits) from the numerical progression representing the balance of the charged amount of the IC card 12 that is acquired from the information of the IC card 12 in Step S300 and is an example of the next record data.

In Step S304, the related object creation unit 224 reads the numerical progression of the predetermined number of digits and the predetermined time stored in Step S210 in FIG. 6. The numerical progression of the predetermined number of digits stored in Step S210 in FIG. 6 is the numerical progression of the predetermined number of digits read in Step S202 of FIG. 6. The predetermined time stored in Step S210 of FIG. 6 is the predetermined time determined according to the difference amount between the numerical progression of the predetermined number of digits read in Step S202 and the charged amount necessary for creating the designated object.

The related object creation unit 224 calculates an elapsed time from the acquisition of the previous record data in Step S200 in FIG. 6 to the acquisition of the next record data in Step S300 in FIG. 9.

The related object creation unit 224 determines whether the calculated elapsed time is equal to or longer than the predetermined time stored in Step S210 in FIG. 6 and the numerical progression of a predetermined number of digits read in Step S302 is increased or decreased from the numerical progression of the predetermined number of digits stored in Step S210 in FIG. 6.

In a case where the calculated elapsed time is equal to or longer than the predetermined time stored in Step S210 of FIG. 6 and the numerical progression of the predetermined number of digits read in Step S302 is not increased or decreased from the numerical progression of the predetermined number of digits stored in Step S210 in FIG. 6, the related object creation unit 224 executes the process of Step S306. In Step S306, the related object creation unit 224 generates a first related object of the designated object.

For example, in a case where the designated object is a designated character, the first related object is a related character related to the designated character. The related character related to the designated character is, for example, an enhanced version of the designated character. The related character related to the designated character may be a color difference version of the designated character. The enhanced version of the designated character may be a character having an initial ability value higher than that of the designated character, a character having an initial level higher than that of the designated character, or a character that has a special skill that the designated character does not have.

In a case where the calculated elapsed time is not equal to or longer than the predetermined time stored in Step S210 in FIG. 6, or in a case where the numerical progression of the predetermined number of digits read in Step S302 is increased or decreased from the numerical progression of the predetermined number of digits stored in Step S210 in FIG. 6 even though the calculated elapsed time is equal to or longer than the predetermined time, the related object creation unit 224 executes the process of Step S308.

In Step S308, the related object creation unit 224 generates a second related object of the designated object. For example, in a case where the designated object is a designated character, the second related object is a related item related to the designated character. The related item related to the designated character is, for example, an item that enhances the designated character. The related item related to the designated character may be an item that can acquire the designated character by acquiring a predetermined number.

In the processing of the flowchart in FIG. 9, the second related object is created in a case where the calculated elapsed time is not equal to or longer than the predetermined time stored in Step S210 in FIG. 6, in other words, in a case where the predetermined time has not elapsed, but the present embodiment is not limited to this example. For example, in a case where the calculated elapsed time is not equal to or longer than the predetermined time stored in Step S210 in FIG. 6, instead of creating the second related object, an instruction to wait for the elapse of the predetermined time, such as “please read the balance from the IC card after the predetermined time has elapsed”, may be displayed.

According to the present embodiment, in a case where the predetermined number of digits of the balance of the charged amount of the IC card 12 is a numerical progression for generating the designated object, the user can create the designated object by causing the information processing apparatus 10 to read the information of the IC card 12.

According to the present embodiment, in a case where the predetermined number of digits of the balance of the charged amount of the IC card 12 is within the allowable range from the numerical progression for generating the designated object, the user causes the information processing apparatus 10 to read the information of the IC card 12, and causes the information processing apparatus 10 to re-read the information of the IC card 12 without increasing or decreasing the balance of the charged amount of the IC card 12 until the predetermined time elapses. In this manner, the first related object of the designated object can be created. Even though the balance of the charged amount of the IC card 12 is increased or decreased before the predetermined time elapses, the user can create the second related object of the designated object by causing the information processing apparatus 10 to re-read the information of the IC card 12.

For example, in the case of a transportation IC card, the user causes the information processing apparatus 10 to read the balance of the IC card 12 before entering a ticket examination area, and causes the information processing apparatus 10 to read the balance of the IC card 12 after exiting the ticket examination area. In a case where the balance of the IC card 12 read from the IC card 12 before entering the ticket examination area coincides with the numerical progression for generating the designated object, the user can acquire the designated object. In a case where the balance of the IC card 12 read from the IC card 12 before entering the ticket examination area is within the allowable range from the numerical progression for generating the designated object, the user can acquire the first related object or the second related object based on whether or not the balance of the IC card 12 read from the IC card 12 after exiting the ticket examination area has changed and whether or not a predetermined time has elapsed.

For example, after entering the ticket examination area, the user exits the ticket examination area after a predetermined time has elapsed. The predetermined time is obtained by a difference between the balance of the IC card 12 read from the IC card 12 before entering the ticket examination area and the numerical progression for generating the designated object. In a case where the balance of the IC card 12 read from the IC card 12 after exiting the ticket examination area has not changed from the balance of the IC card 12 read from the IC card 12 before entering the ticket examination area, the related character can be acquired. In a case where the balance of the IC card 12 read from the IC card 12 after exiting the ticket examination area has changed from the balance of the IC card 12 read from the IC card 12 before entering the ticket examination area, the user can acquire the related item of the designated object.

For example, the user may read the second balance from the IC card 12 before exiting the ticket examination area, without exiting the ticket examination area until a predetermined time elapses. In this case, the user can adjust the balance of the IC card 12 before exiting the ticket examination area to coincide or not coincide with the first balance by charging or the like. The user adjusts the balance of the IC card 12 by charging or the like before exiting the ticket examination area in consideration of the change in the balance of the IC card 12 caused by exiting the ticket examination area, whereby the balance of the IC card 12 after exiting the ticket examination area can be adjusted to coincide or not to coincide with the first balance.

In the present embodiment, as described above, since there are two timings at which the information of the IC card 12 is read by the information processing apparatus 10, the IC card 12 from which the first information is read may be different from the IC card 12 from which the second information is read. In this case, in a case where the first information coincides with the numerical progression for generating the designated object, the information processing apparatus 10 causes the user to acquire the designated object. The information processing apparatus 10 may cause the user to acquire a highly valuable related object in a case where the second information read from the IC card 12 after a predetermined time has elapsed coincides with the first information read from a different IC card 12.

In the present embodiment, as described above, an example in which one IC card 12 from which information is read for the first time and one IC card 12 from which information is read for the second time are provided has been described, but a plurality of the IC cards may be used.

For example, the user reads the balance from two IC cards 12 at a timing of reading the information for the first time. The information processing apparatus 10 uses the total balance read from the two IC cards 12. In a case where the total balance coincides with the numerical progression for generating the designated object, the user can acquire the designated object. In a case where the total balance falls within the allowable range from the numerical progression for generating the designated object, the user reads the second balance after a predetermined time has elapsed, from the two IC cards 12 from which the balance has been read for the first time.

In a case where the second read balance of each of the two IC cards 12 has changed, the information processing apparatus 10 causes the user to acquire, for example, a related object of an enhanced version (having a special skill or the like) of the designated object. In a case where the second read balance of any one of the two IC cards 12 has changed, the information processing apparatus 10 causes the user to acquire, for example, a related object of an enhanced version (color difference or the like) of the designated object.

In a case where the second read balance of each of the two IC cards 12 has not changed, the information processing apparatus 10 causes the user to acquire, for example, a related object that is a related item of the designated object.

As described above, according to the present embodiment, it is possible to impart game properties to object creation performed by reading information of the IC card 12.

### Second Embodiment

In the first embodiment, the example in which record data that varies by use is registered as one piece of information of the IC card 12 has been described. Examples of the type of NFC of the IC card 12 include Type A, Type B, and Type F. Information registered in the IC card 12 differs depending on the type of NFC. In a second embodiment, the type of NFC of an IC card 12 is determined, and the object creation processing illustrated in FIG. 5 is performed by using information of the IC card that can be read from the IC card 12.

An information processing apparatus 10 can acquire information of the type of NFC (such as Type F) from the IC card 12 by using a function. The information processing apparatus 10 can acquire information of the type (transportation system A or the like) of the IC card 12 from the IC card 12 in a procedure conforming to the specification of the acquired type of NFC. The information processing apparatus 10 can read information of the IC card 12 to be used for processing which will be described later, in a procedure conforming to the specifications of the acquired type of NFC and the type of the IC card 12.

[NFC with Record Data of Balance] In a case where the type of NFC of the IC card 12 is NFC with record data of the balance, the information processing apparatus 10 performs processing as follows. For example, the IC card 12 in which the type of NFC is Type F and the balance of electronic money or the like is registered as record data is an example of the NFC IC card 12 with varying record data of the balance or the like. Here, an example of reading the balance from the IC card 12 will be described with reference to FIG. 5.

In Step S100, the information processing apparatus 10 receives, from the user, a start operation of an application such as a game or an SNS in which a character and an item are created and used as an object, and starts the application.

In Step S102, the information processing apparatus 10 receives an object creation instruction from the user who uses the started application, for example. The IC card information acquisition unit 220 in the information processing apparatus 10 determines the type of NFC of the IC card 12 and the type of the IC card 12, and repeats the process of Step S104 until the balance is read from the IC card 12. In a case where the balance is read from the IC card 12, the IC card information acquisition unit 220 in the information processing apparatus 10 acquires a time point at which the balance is read from the IC card 12.

In a case where the balance is read out from the IC card 12, the designated object creation unit 222 in the information processing apparatus 10 determines in Step S106 whether or not this reading is re-reading after an announcement production. In a case where this reading is not re-reading after the announcement production, the designated object creation unit 222 executes a designated object creation process of Step S108. In the case of the re-reading after the announcement production, the related object creation unit 224 executes a re-reading process of Step S110.

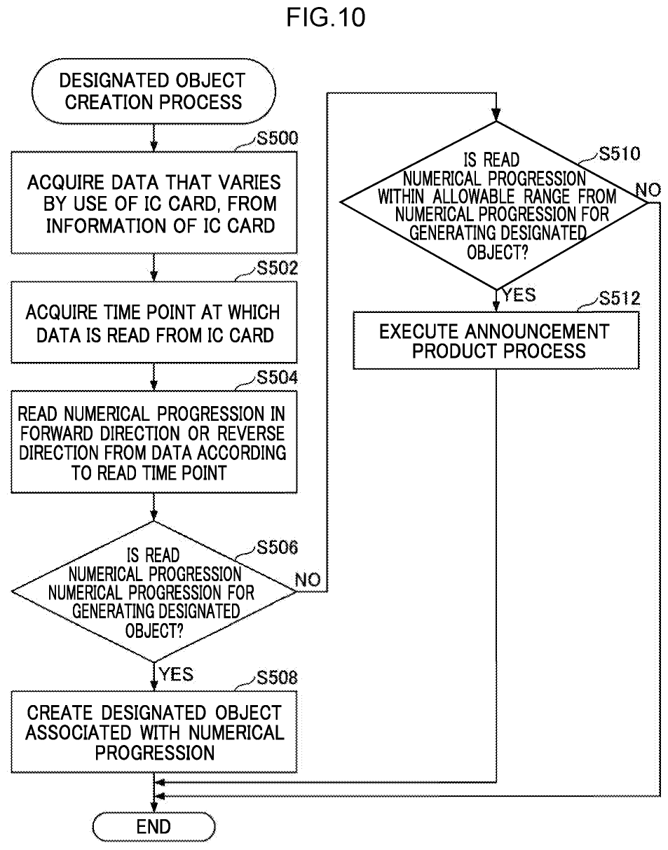

In Step S108, the designated object creation unit 222 creates a designated object by the procedure illustrated in FIG. 10, for example, using the balance read from the IC card 12.

FIG. 10 is a flowchart of an example of a designated object creation process in the case of NFC with record data of the balance. In Step S500, the designated object creation unit 222 acquires the balance read from the IC card 12. The balance is an example of a numerical progression from which any number of digits can be read.

In Step S502, the designated object creation unit 222 acquires a time point at which the balance is read from the IC card 12. In Step S504, the designated object creation unit 222 determines whether the time point read in Step S502 is a time section in which the balance is read in the forward direction or a time section in which the balance is read in the reverse direction. For example, the designated object creation unit 222 may set a time section in which the balance is read in the reverse direction and determine a time section other than the set time section, as the time section in which the balance is read in the forward direction. In the time section for performing reading in the forward direction, the designated object creation unit 222 reads a numerical progression of a predetermined number of digits (for example, the last three digits) in the forward direction from a numerical progression representing the balance acquired in Step S500. For example, in a case where the balance is “5123 yen”, the designated object creation unit 222 reads “123”. In the time section for performing reading in the reverse direction, the designated object creation unit 222 reads a numerical progression of a predetermined number of digits in the reverse direction from the numerical progression representing the balance acquired in Step S500. For example, in a case where the balance is “5123 yen”, the designated object creation unit 222 reads “321”.

In Step S506, the designated object creation unit 222 determines whether or not the numerical progression of the predetermined number of digits read in Step S504 is, for example, a numerical progression for generating a designated object managed by the table of FIG. 7.

In a case where it is determined that the numerical progression of the predetermined number of digits read in Step S504 coincides with the numerical progression for generating the designated object, the designated object creation unit 222 executes the process of Step S508. In Step S508, the designated object creation unit 222 refers to the table in FIG. 7 and creates a designated object associated with the numerical progression of the predetermined number of digits read in Step S504.

In a case where it is determined that the numerical progression of the predetermined number of digits read in Step S504 is not the numerical progression for generating the designated object, the designated object creation unit 222 proceeds to the process of Step S510. In Step S510, the related object creation unit 224 determines whether or not the numerical progression of the predetermined number of digits read in Step S504 is within an allowable range (for example, within ±5) from the numerical progression for generating the designated object.

In a case where the numerical progression of the predetermined number of digits read in Step S504 is within the allowable range from the numerical progression for generating the designated object, the related object creation unit 224 executes the process of Step S512. In Step S512, the related object creation unit 224 stores the numerical progression of the predetermined number of digits read in Step S504 and the time point acquired in Step S502.

In Step S512, the related object creation unit 224 stores a predetermined time corresponding to a difference amount between the numerical progression of the predetermined number of digits read in Step S504 and the balance necessary for creating the designated object. In Step S512, the related object creation unit 224 executes an announcement production process of displaying an announcement production screen 1000 illustrated in FIG. 8, for example.

In a case where the numerical progression of the predetermined number of digits read in Step S504 is not within the allowable range from the numerical progression for generating the designated object, the related object creation unit 224 skips the announcement production process of Step S512. Thus, in a case where the numerical progression of the predetermined number of digits read in Step S504 is not within the allowable range from the numerical progression for generating the designated object, the related object creation unit 224 does not create the related object.

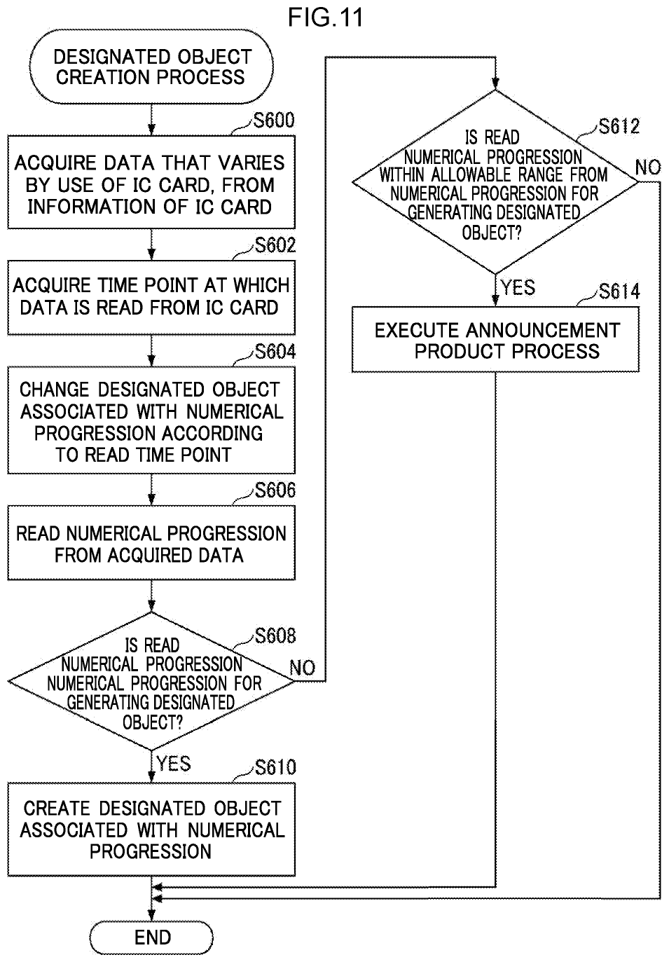

In Step S108, the designated object creation unit 222 may create a designated object by the procedure illustrated in FIG. 11, for example, using the balance read from the IC card 12.

FIG. 11 is a flowchart of another example of the designated object creation process in the case of the NFC with the record data of the balance. In Step S600, the designated object creation unit 222 acquires the balance read from the IC card 12. The balance is an example of a numerical progression from which any number of digits can be read.

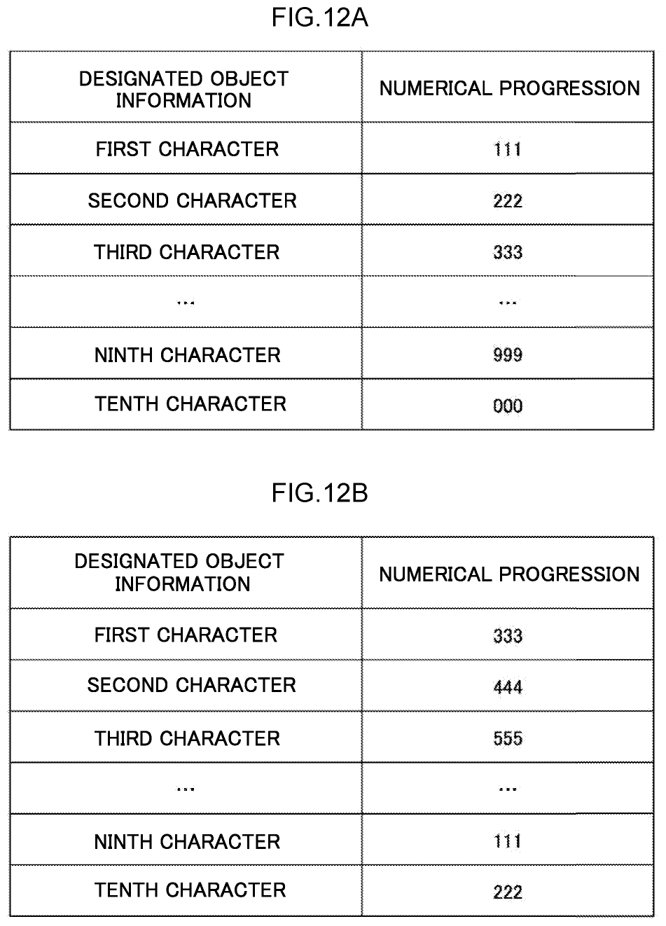

In Step S602, the designated object creation unit 222 acquires a time point at which the balance is read from the IC card 12. In Step S604, the designated object creation unit 222 changes the designated object associated with the numerical progression, for example, by performing switching between the tables in FIGS. 12A and 12B according to the read time point.

FIGS. 12A and 12B are examples of the table in which the designated object information is associated with the numerical progression for generating designated objects. The designated object information is an example of identification information of the designated object.

For example, the designated object creation unit 222 determines whether the time point acquired in Step S602 is a time section in which the table in FIG. 12A is used or a time section in which the table in FIG. 12B is used. For example, the designated object creation unit 222 uses the table in FIG. 12A in a case where the time point acquired in Step S602 is an even hour such as 14:00 to 14:59 and the like, and uses the table in FIG. 12B in a case where the time point is an odd hour such as 11:00 to 11:59 and the like.

In Step S606, the designated object creation unit 222 reads a numerical progression of a predetermined number of digits (for example, the last three digits) from the numerical progression representing the balance acquired in Step S600. In Step S608, the designated object creation unit 222 determines whether or not the numerical progression of the predetermined number of digits read in Step S606 is, for example, a numerical progression for generating a designated object managed by the table of FIG. 12A or 12B.

In a case where it is determined that the numerical progression of the predetermined number of digits read in Step S606 coincides with the numerical progression for generating the designated object, the designated object creation unit 222 executes the process of Step S610. In Step S610, the designated object creation unit 222 refers to the table in FIG. 12A or 12B and creates a designated object associated with the numerical progression of the predetermined number of digits read in Step S606.

In a case where it is determined that the numerical progression of the predetermined number of digits read in Step S606 is not the numerical progression for generating the designated object, the designated object creation unit 222 proceeds to the process of Step S612. In Step S612, the related object creation unit 224 determines whether or not the numerical progression of the predetermined number of digits read in Step S606 is within an allowable range (for example, within ±5) from the numerical progression for generating the designated object.

In a case where the numerical progression of the predetermined number of digits read in Step S606 is within the allowable range from the numerical progression for generating the designated object, the related object creation unit 224 executes the process of Step S614. In Step S614, the related object creation unit 224 stores the numerical progression of the predetermined number of digits read in Step S606 and the time point acquired in Step S602.

In Step S614, the related object creation unit 224 stores a predetermined time corresponding to a difference amount between the numerical progression of the predetermined number of digits read in Step S606 and the balance necessary for creating the designated object. In Step S614, the related object creation unit 224 executes an announcement production process of displaying an announcement production screen 1000 illustrated in FIG. 8, for example.

In a case where the numerical progression of the predetermined number of digits read in Step S606 is not within the allowable range from the numerical progression for generating the designated object, the related object creation unit 224 skips the announcement production process of Step S614. Thus, in a case where the numerical progression of the predetermined number of digits read in Step S606 is not within the allowable range from the numerical progression for generating the designated object, the related object creation unit 224 does not create the related object.

The process of differing a direction of reading the numerical progression of a predetermined number of digits from the numerical progression representing the balance in Step S504 illustrated in FIG. 10 depending on the time point at which the balance is read from the IC card 12, and the process of differing the designated object associated with the numerical progression of Step S604 illustrated in FIG. 11 depending on the time point at which the balance is read from the IC card 12 may be executed in combination.

According to the present embodiment, even though there is no change in the balance of the IC card 12, the result of the process by the information processing apparatus 10 differs depending on the time point at which the balance is read from the IC card 12. Thus, it is possible to impart the game properties to object creation performed by reading information of the IC card 12.

[NFC Having Unique UID without Record Data of Balance]

In a case where the type of NFC of the IC card 12 is NFC having a unique UID without record data of the balance, the information processing apparatus 10 performs processing as follows. For example, the IC card 12 in which the type of NFC is Type A or Type F and the balance of electronic money or the like is not registered is an example of the IC card 12 of NFC having not-varying record data of the UID or the like without varying record data of the balance or the like. Here, an example of reading the UID from the IC card 12 will be described with reference to FIG. 5. The UID is a fixed ID number of the IC card 12 or the like, and is unique identification information that is recorded in the IC tag or the IC chip at the time of manufacturing the IC card 12 and cannot be rewritten.

In Step S100, the information processing apparatus 10 receives, from the user, a start operation of an application such as a game or an SNS in which a character and an item are created and used as an object, and starts the application.

In Step S102, the information processing apparatus 10 receives an object creation instruction from the user who uses the started application, for example. The IC card information acquisition unit 220 in the information processing apparatus 10 determines the type of NFC of the IC card 12 and the type of the IC card 12, and repeats the process of Step S104 until the UID is read from the IC card 12.

The IC card information acquisition unit 220 in the information processing apparatus 10 reads the UID from the IC card 12, and acquires a time point at which the UID is read from the IC card 12. In a case where the UID is read out from the IC card 12, the designated object creation unit 222 in the information processing apparatus 10 determines in Step S106 whether or not this reading is re-reading after an announcement production. In a case where this reading is not re-reading after the announcement production, the designated object creation unit 222 executes a designated object creation process of Step S108. In the case of the re-reading after the announcement production, the related object creation unit 224 executes the re-reading process of Step S110.

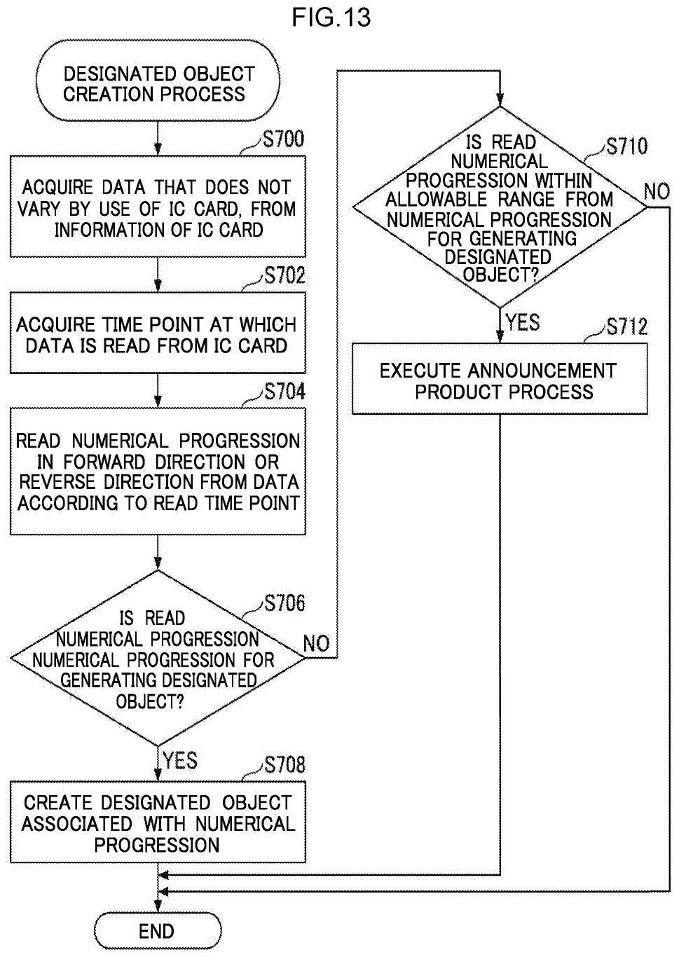

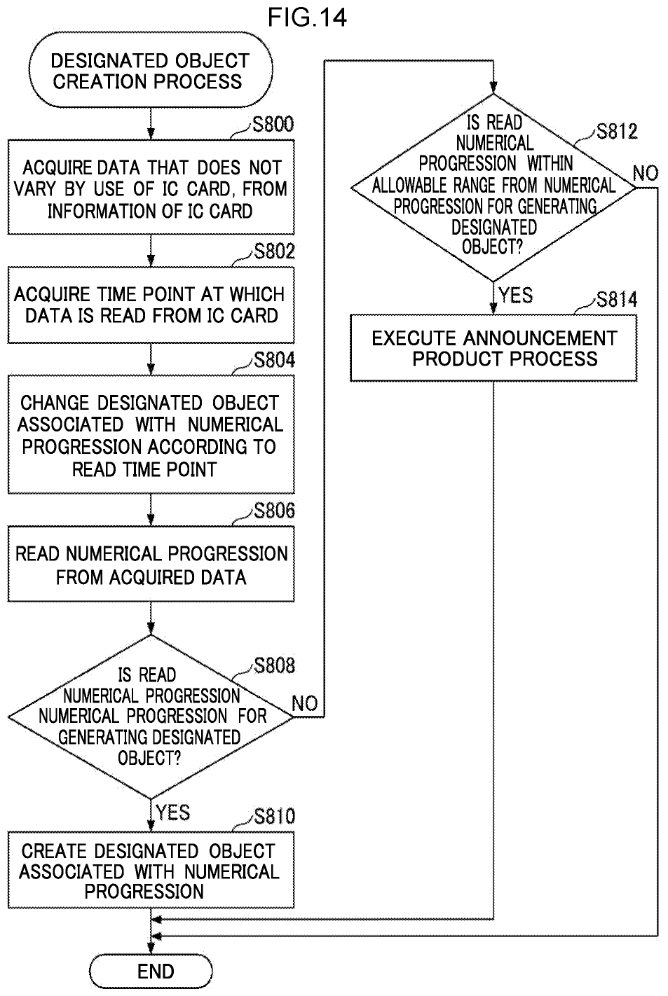

In Step S108, the designated object creation unit 222 creates a designated object by the procedure illustrated in FIG. 13, for example, using the unique UID read from the IC card 12.

FIG. 13 is a flowchart of an example of the designated object creation process in the case of NFC having the UID without record data of the balance. In Step S700, the designated object creation unit 222 acquires the unique UID read from the IC card 12. The unique UID is an example of data that does not vary by the use of the IC card 12. The designated object creation unit 222 generates, for example, a hash value from the unique UID, and uses the generated hash value as an example of a numerical progression from which any number of digits can be read.

In Step S702, the designated object creation unit 222 acquires a time point at which the unique UID is read from the IC card 12. In Step S704, the designated object creation unit 222 determines whether the time point read in Step S702 is a time section in which the hash value generated from the unique UID is read in the forward direction or a time section in which the hash value is read in the reverse direction. In the time section for performing reading in the forward direction, the designated object creation unit 222 reads a numerical progression of a predetermined number of digits (for example, the last three digits) in the forward direction from a numerical progression of hash values generated from the unique UID. In the time section for performing reading in the reverse direction, the designated object creation unit 222 reads a numerical progression of a predetermined number of digits (for example, the last three digits) in the reverse direction from the numerical progression of the hash values generated from the unique UID.

In Step S706, the designated object creation unit 222 determines whether or not the numerical progression of the predetermined number of digits read in Step S704 is, for example, a numerical progression for generating a designated object managed by the table of FIG. 7.

In a case where it is determined that the numerical progression of the predetermined number of digits read in Step S704 coincides with the numerical progression for generating the designated object, the designated object creation unit 222 executes the process of Step S708. In Step S708, the designated object creation unit 222 refers to the table in FIG. 7 and creates a designated object associated with the numerical progression of the predetermined number of digits read in Step S704.

In a case where it is determined that the numerical progression of the predetermined number of digits read in Step S704 is not the numerical progression for generating the designated object, the designated object creation unit 222 proceeds to the process of Step S710. In Step S710, the related object creation unit 224 determines whether or not the numerical progression of the predetermined number of digits read in Step S704 is within an allowable range (for example, within ±5) from the numerical progression for generating the designated object.

In a case where the numerical progression of the predetermined number of digits read in Step S704 is within the allowable range from the numerical progression for generating the designated object, the related object creation unit 224 executes the process of Step S712. In Step S712, the related object creation unit 224 stores the numerical progression of the predetermined number of digits read in Step S704 and the time point acquired in Step S702.

In Step S712, the related object creation unit 224 stores a predetermined time corresponding to a difference between the numerical progression of the predetermined number of digits read in Step S704 and the numerical progression for generating the designated object. In Step S712, the related object creation unit 224 executes an announcement production process of displaying an announcement production screen.

In a case where the numerical progression of the predetermined number of digits read in Step S704 is not within the allowable range from the numerical progression for generating the designated object, the related object creation unit 224 skips the announcement production process of Step S712. Thus, in a case where the numerical progression of the predetermined number of digits read in Step S704 is not within the allowable range from the numerical progression for generating the designated object, the related object creation unit 224 does not create the related object.

In Step S108, the designated object creation unit 222 may create a designated object by the procedure illustrated in FIG. 14, for example, using the unique UID read from the IC card 12.

FIG. 14 is a flowchart of another example of the designated object creation process in the case of the NFC having the UID without the record data of the balance. In Step S800, the designated object creation unit 222 acquires the unique UID read from the IC card 12. The unique UID is an example of data that does not vary by the use of the IC card 12. The designated object creation unit 222 generates, for example, a hash value from the unique UID, and uses the generated hash value as an example of a numerical progression from which any number of digits can be read.

In Step S802, the designated object creation unit 222 acquires a time point at which the unique UID is read from the IC card 12. In Step S804, the designated object creation unit 222 changes the designated object associated with the numerical progression, for example, by performing switching between the tables in FIGS. 12A and 12B according to the read time point. In Step S806, the designated object creation unit 222 reads a numerical progression of a predetermined number of digits (for example, the last three digits) from the numerical progression of hash values generated from the unique UID.

In Step S808, the designated object creation unit 222 determines whether or not the numerical progression of the predetermined number of digits read in Step S806 is, for example, a numerical progression for generating a designated object managed by the table of FIG. 12A or 12B.

In a case where it is determined that the numerical progression of the predetermined number of digits read in Step S806 coincides with the numerical progression for generating the designated object, the designated object creation unit 222 executes the process of Step S810. In Step S810, the designated object creation unit 222 refers to the table in FIG. 12A or 12B and creates a designated object associated with the numerical progression of the predetermined number of digits read in Step S806.

In a case where it is determined that the numerical progression of the predetermined number of digits read in Step S806 is not the numerical progression for generating the designated object, the designated object creation unit 222 proceeds to the process of Step S812. In Step S812, the related object creation unit 224 determines whether or not the numerical progression of the predetermined number of digits read in Step S806 is within an allowable range (for example, within ±5) from the numerical progression for generating the designated object.

In a case where the numerical progression of the predetermined number of digits read in Step S806 is within the allowable range from the numerical progression for generating the designated object, the related object creation unit 224 executes the process of Step S814. In Step S814, the related object creation unit 224 stores the numerical progression of the predetermined number of digits read in Step S806 and the time point acquired in Step S802.

In Step S814, the related object creation unit 224 stores a predetermined time corresponding to a difference between the numerical progression of the predetermined number of digits read in Step S806 and the numerical progression for generating the designated object. In Step S814, the related object creation unit 224 executes an announcement production process of displaying an announcement production screen.

In a case where the numerical progression of the predetermined number of digits read in Step S806 is not within the allowable range from the numerical progression for generating the designated object, the related object creation unit 224 skips the announcement production process of Step S814. Thus, in a case where the numerical progression of the predetermined number of digits read in Step S806 is not within the allowable range from the numerical progression for generating the designated object, the related object creation unit 224 does not create the related object.

The process of differing a direction of reading the numerical progression of a predetermined number of digits from the numerical progression of the hash values generated from the unique UID in Step S704 illustrated in FIG. 13 depending on the time point at which the unique UID is read from the IC card 12, and the process of differing the designated object associated with the numerical progression of Step S804 illustrated in FIG. 14 depending on the time point at which the unique UID is read from the IC card 12 may be executed in combination.

For example, the information processing apparatus 10 can execute four patterns of processing based on a combination of the direction (forward direction and reverse direction) of reading the numerical progression of a predetermined number of digits from the numerical progression of hash values generated from the unique UID and the numerical progression for generating the designated object managed by the table of FIG. 12A or 12B, for example.

According to the present embodiment, even in the IC card 12 having no record data that varies by the use of the balance or the like, the result of the process by the information processing apparatus 10 differs depending on the time point at which the unique UID is read from the IC card 12. Thus, it is possible to impart the game properties to the object creation performed by reading the information of the IC card 12.

[NFC without Record Data of Balance and Unique UID]

In a case where the type of NFC of the IC card 12 is NFC without record data of the balance and the unique UID, the information processing apparatus 10 performs processing as follows. For example, the IC card 12 in which the type of NFC is Type B and the balance of electronic money or the like is not registered is an example of the IC card 12 of NFC having record data of the UID or the like, which randomly varies, without varying record data of the balance or the like. Here, an example of reading the UID that randomly varies from the IC card 12 will be described with reference to FIG. 5. The UID that randomly varies is referred to as a random UID below in order to be distinguished from a unique UID.

In Step S100, the information processing apparatus 10 receives, from the user, a start operation of an application such as a game or an SNS in which a character and an item are created and used as an object, and starts the application.

In Step S102, the information processing apparatus 10 receives an object creation instruction from the user who uses the started application, for example. The IC card information acquisition unit 220 in the information processing apparatus 10 determines the type of NFC of the IC card 12 and the type of the IC card 12, and repeats the process of Step S104 until the random UID is read from the IC card 12.

The IC card information acquisition unit 220 in the information processing apparatus 10 reads the random UID from the IC card 12, and acquires a time point at which the random UID is read from the IC card 12. In a case where the random UID is read out from the IC card 12, the designated object creation unit 222 in the information processing apparatus 10 determines in Step S106 whether or not this reading is re-reading after an announcement production. In a case where this reading is not re-reading after the announcement production, the designated object creation unit 222 executes a designated object creation process of Step S108. In the case of the re-reading after the announcement production, the related object creation unit 224 executes the re-reading process of Step S110.

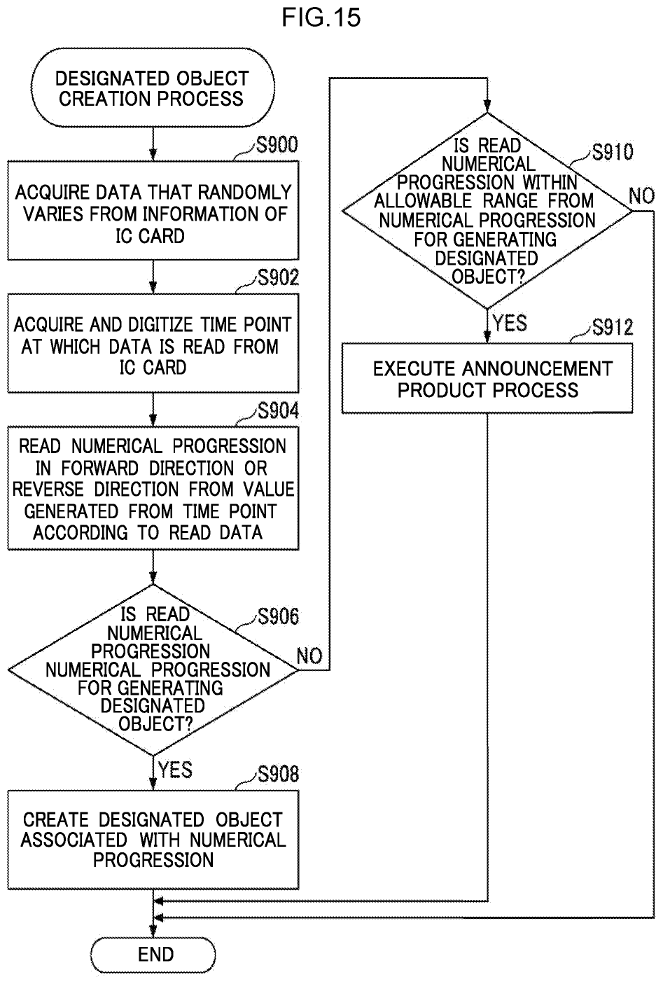

In Step S108, the designated object creation unit 222 creates a designated object by the procedure illustrated in FIG. 15, for example, using the random UID read from the IC card 12.

FIG. 15 is a flowchart of an example of the designated object creation process in the case of NFC having the random UID without record data of the balance. In Step S900, the designated object creation unit 222 acquires the random UID read from the IC card 12. The designated object creation unit 222 generates, for example, a hash value from the random UID, and uses the generated hash value as an example of a numerical progression from which any number of digits can be read.

In Step S902, the designated object creation unit 222 acquires a time point at which the random UID is read from the IC card 12, and generates a value (numerical progression) from which any number of digits can be read, from the acquired time point according to a predetermined rule.

In Step S904, the designated object creation unit 222 determines whether the hash value generated in Step S900 is a hash value for reading the value generated in Step S902 in the forward direction or a hash value for reading the value in the reverse direction. For example, the designated object creation unit 222 may determine whether the hash value is a hash value read in the forward direction or a hash value read in the reverse direction, based on whether or not the hash value is an even number or a multiple of a predetermined value, or the like.

In the case of the hash value read in the forward direction, the designated object creation unit 222 reads a numerical progression of a predetermined number of digits (for example, the last three digits) in the forward direction from the value generated from the time point. In the case of the hash value read in the reverse direction, the designated object creation unit 222 reads a numerical progression of a predetermined number of digits (for example, the last three digits) in the reverse direction from the value generated from the time point.

In Step S906, the designated object creation unit 222 determines whether or not the numerical progression of the predetermined number of digits read in Step S904 is, for example, a numerical progression for generating a designated object managed by the table of FIG. 7.

In a case where it is determined that the numerical progression of the predetermined number of digits read in Step S904 coincides with the numerical progression for generating the designated object, the designated object creation unit 222 executes the process of Step S908. In Step S908, the designated object creation unit 222 refers to the table in FIG. 7 and creates a designated object associated with the numerical progression of the predetermined number of digits read in Step S904.

In a case where it is determined that the numerical progression of the predetermined number of digits read in Step S904 is not the numerical progression for generating the designated object, the designated object creation unit 222 proceeds to the process of Step S910. In Step S910, the related object creation unit 224 determines whether or not the numerical progression of the predetermined number of digits read in Step S904 is within an allowable range (for example, within ±5) from the numerical progression for generating the designated object.

In a case where the numerical progression of the predetermined number of digits read in Step S904 is within the allowable range from the numerical progression for generating the designated object, the related object creation unit 224 executes the process of Step S912. In Step S912, the related object creation unit 224 stores the numerical progression of the predetermined number of digits read in Step S904 and the time point acquired in Step S902.

In Step S912, the related object creation unit 224 stores a predetermined time corresponding to a difference between the numerical progression of the predetermined number of digits read in Step S904 and the numerical progression for generating the designated object. In Step S912, the related object creation unit 224 executes an announcement production process of displaying an announcement production screen.

In a case where the numerical progression of the predetermined number of digits read in Step S904 is not within the allowable range from the numerical progression for generating the designated object, the related object creation unit 224 skips the announcement production process of Step S912. Thus, in a case where the numerical progression of the predetermined number of digits read in Step S904 is not within the allowable range from the numerical progression for generating the designated object, the related object creation unit 224 does not create the related object.

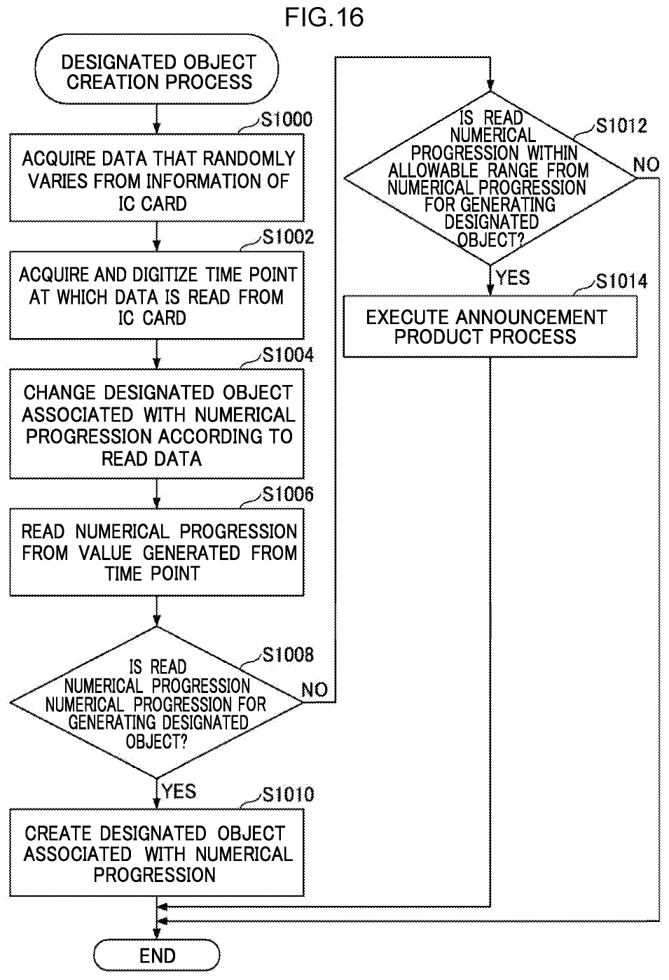

In Step S108, the designated object creation unit 222 may create a designated object by the procedure illustrated in FIG. 16, for example, using the random UID read from the IC card 12.

FIG. 16 is a flowchart of another example of the designated object creation process in the case of the NFC having the random UID without the record data of the balance. In Step S1000, the designated object creation unit 222 acquires the random UID read from the IC card 12. The designated object creation unit 222 generates, for example, a hash value from the random UID, and uses the generated hash value as an example of a numerical progression from which any number of digits can be read.

In Step S1002, the designated object creation unit 222 acquires a time point at which the random UID is read from the IC card 12, and generates a value (numerical progression) from which any number of digits can be read, from the acquired time point according to a predetermined rule. In Step S1004, the designated object creation unit 222 changes the designated object associated with the numerical progression, for example, by performing switching between the tables in FIGS. 12A and 12B according to the hash value generated in Step S900.

In Step S1006, the designated object creation unit 222 reads a numerical progression of a predetermined number of digits (for example, the last three digits) from the value generated from the time point. In Step S1008, the designated object creation unit 222 determines whether or not the numerical progression of the predetermined number of digits read in Step S1006 is, for example, a numerical progression for generating a designated object managed by the table of FIG. 12A or 12B.

In a case where it is determined that the numerical progression of the predetermined number of digits read in Step S1006 coincides with the numerical progression for generating the designated object, the designated object creation unit 222 executes the process of Step S1010.

In Step S1010, the designated object creation unit 222 refers to the table in FIG. 12A or 12B and creates a designated object associated with the numerical progression of the predetermined number of digits read in Step S1006.

In a case where it is determined that the numerical progression of the predetermined number of digits read in Step S1006 is not the numerical progression for generating the designated object, the designated object creation unit 222 proceeds to the process of Step S1012. In Step S1012, the related object creation unit 224 determines whether or not the numerical progression of the predetermined number of digits read in Step S1006 is within an allowable range (for example, within ±5) from the numerical progression for generating the designated object.

In a case where the numerical progression of the predetermined number of digits read in Step S1006 is within the allowable range from the numerical progression for generating the designated object, the related object creation unit 224 executes the process of Step S1014. In Step S1014, the related object creation unit 224 stores the numerical progression of the predetermined number of digits read in Step S1006 and the time point acquired in Step S1002.

In Step S1014, the related object creation unit 224 stores a predetermined time corresponding to a difference between the numerical progression of the predetermined number of digits read in Step S1006 and the numerical progression for generating the designated object. In Step S1014, the related object creation unit 224 executes an announcement production process of displaying an announcement production screen.

In a case where the numerical progression of the predetermined number of digits read in Step S1006 is not within the allowable range from the numerical progression for generating the designated object, the related object creation unit 224 skips the announcement production process of Step S1014. Thus, in a case where the numerical progression of the predetermined number of digits read in Step S1006 is not within the allowable range from the numerical progression for generating the designated object, the related object creation unit 224 does not create the related object.

The process of differing the direction of reading the numerical progression of a predetermined number of digits from the value generated from the time point in Step S902 illustrated in FIG. 15 depending on the hash value of the random UID acquired from the IC card 12, and the process of differing the designated object associated with the numerical progression of Step S904 illustrated in FIG. 16 depending on the hash value of the random UID acquired from the IC card 12 may be executed in combination.

For example, the information processing apparatus 10 can execute four patterns of processing based on a combination of the direction (forward direction and reverse direction) of reading the numerical progression of a predetermined number of digits from the value generated from the time point and the numerical progression for generating the designated object managed by the table of FIG. 12A or 12B, for example.

According to the present embodiment, even in the IC card 12 having no record data that varies by the use of the balance or the like, the result of the process by the information processing apparatus 10 differs depending on the random UID read from the IC card 12. Thus, it is possible to impart the game properties to the object creation performed by reading the information of the IC card 12.

It should be considered that the information processing apparatus according to the disclosed embodiment is illustrative and not restrictive. The above embodiments can be modified and improved in various forms without departing from the scope and spirit of the appended claims. In addition, the matters described in the plurality of embodiments described above can take other configurations in a range without contradictory, and can be combined in a range without contradictory.

Hitherto, although the present invention has been described based on examples, the present invention is not limited to the above examples, and various modifications can be made within the scope described in the claims. This application claims priority to Japanese Patent Application No. 2021-174957 filed on Oct. 26, 2021 and Japanese Patent Application No. 2022-087959 filed on May 30, 2022, the entire contents of which are incorporated herein by reference.

### [Supplementary Note]

The invention described in the present embodiment has been described so that those skilled in the art can further carry out the following invention.

A computer-readable recording medium recording a program for causing an information processing apparatus to function as:
designated object creation means for creating a designated object in a case where record data of an IC card, which is read from an IC tag or an IC chip in which information of the IC card is registered satisfies a condition; and
related object creation means for creating, in a case where the record data does not satisfy the condition, a related object according to an elapsed time from reading of the record data to reading of next record data and presence or absence of a change in the next record data read.

### REFERENCE SIGNS LIST

10 Information Processing Apparatus
12 IC Card
14 Server Device
18 Communication Network
200 Control Unit
202 Operation Receiving Unit
204 Output Control Unit
206 Communication Unit
208 Near Field Communication Unit
210 Storage Unit
220 IC Card Information Acquisition Unit
222 Designated Object Creation Unit
224 Related Object Creation Unit
226 Character Control Unit
228 Item Control Unit
232 Program
234 IC Card Data
236 Character Data
238 Item Data

1. An information processing apparatus comprising:
designated object creation means for creating a designated object in a case where record data of an IC card, which is read from an IC tag or an IC chip in which information of the IC card is registered satisfies a condition; and
related object creation means for creating, in a case where the record data does not satisfy the condition, a related object according to an elapsed time from reading of the record data to reading of next record data and presence or absence of a change in the next record data read.

2. The information processing apparatus according to claim 1, further comprising:
IC card information acquisition means for determining a type of near field communication technology of the IC card, and reading the record data varying by use of the IC card, from the IC card, wherein
the condition is coinciding between at least a part of the record data and a setting value associated with the designated object, and
in a case where it is determined that the record data does not satisfy the condition, the related-object creation means creates a first related object in a case where there is no change in the next record data read after a time corresponding to a difference between at least the part of the record data and the setting value has elapsed, and a second related object in a case where there is a change in the next record data read.

3. The information processing apparatus according to claim 2, wherein
the related-object creation means creates the first related object or the second related object at a timing of reading the next record data in a case where the difference from the setting value is within a predetermined range.

4. The information processing apparatus according to claim 2, wherein
the designated object creation means reads at least a part of the record data in a forward direction or a reverse direction according to a time point at which the record data is read from the IC card, and creates the designated object in a case where a condition that at least the part of the record data read in the forward direction or the reverse direction coincides with the setting value associated with the designated object is satisfied.

5. The information processing apparatus according to claim 2, wherein
the designated object creation means changes the setting value associated with the designated object, according to a time point at which the record data is read from the IC card.

6. The information processing apparatus according to claim 1, further comprising:
IC card information acquisition means for determining a type of near field communication technology of the IC card, and reading the record data that does not vary by use of the IC card, from the IC card, wherein
the designated object creation means reads at least a part of values generated from the record data in a forward direction or a reverse direction according to a time point at which the record data is read from the IC card, and creates the designated object in a case where a condition that at least the part of the values read in the forward direction or the reverse direction coincides with a setting value associated with the designated object is satisfied.

7. The information processing apparatus according to claim 1, wherein
the designated object creation means changes the setting value associated with the designated object, according to a time point at which the record data is read from the IC card.

8. The information processing apparatus according to claim 1, further comprising:
IC card information acquisition means for determining a type of near field communication technology of the IC card, and reading identification information of the IC card, which randomly varies, as the record data that randomly varies, wherein
the designated object creation means reads at least a part of values generated from a time point at which the record data is read, in a forward direction or a reverse direction according to the record data read from the IC card, and creates the designated object in a case where a condition that at least the part of the values read in the forward direction or the reverse direction coincides with a setting value associated with the designated object is satisfied.

9. The information processing apparatus according to claim 1, wherein
the designated object creation means changes the setting value associated with the designated object, according to the record data read from the IC card.

10. The information processing apparatus according to claim 2, wherein
the designated object is a designated character, and
the first related object is a related character related to the designated character.

11. The information processing apparatus according to claim 1, wherein
the IC card from which the record data used to determine whether or not the condition is satisfied is read is different from the IC card from which the next record data is read.

12. The information processing apparatus according to claim 1, wherein
the record data used to determine whether or not the condition is satisfied and the record data read next are the record data read from a plurality of the IC cards.

13. The information processing apparatus according to claim 1, wherein
the information processing apparatus is an information communication terminal on which the IC tag or the IC chip is mounted.

14. The information processing apparatus according to claim 1, further comprising:
acquisition means for acquiring the record data from an information communication terminal on which the IC tag or the IC chip is mounted or the IC card into which the IC tag or the IC chip is built.

15. A program for causing an information processing apparatus to function as:
designated object creation means for creating a designated object in a case where record data of an IC card, which is read from an IC tag or an IC chip in which information of the IC card is registered satisfies a condition; and
related object creation means for creating, in a case where the record data does not satisfy the condition, a related object according to an elapsed time from reading of the record data to reading of next record data and presence or absence of a change in the next record data read.

16. An object creation method performed by an information processing apparatus, the object creation method comprising:
a designated object creation step of creating a designated object in a case where record data of an IC card, which is read from an IC tag or an IC chip in which information of the IC card is registered satisfies a condition; and
a related object creation step of creating, in a case where the record data does not satisfy the condition, a related object according to an elapsed time from reading of the record data to reading of next record data and presence or absence of a change in the next record data read.
